(19) United States
(12) Patent Application Publication
(10) Pub. No.: US 2006/0224310 A1
(43) Pub. Date: Oct. 5, 2006

(54) Informative visual image matrix

(76) Inventor: John Richardson Innes, Knoxville, TN (US)

Correspondence Address: PITTS AND BRITTIAN P C, P O BOX 51295, KNOXVILLE, TN, 37950-1295, US

(21) Appl. No.: 11/210,987

(22) Filed: Aug. 24, 2005

Related U.S. Application Data
(60) Provisional application No. 60/667,363, filed on Apr. 1, 2005.

(51) Int. Cl. G01C 21/30

(52) U.S. Cl. 701/208; 340/995.1

(57) ABSTRACT

An informative visual image matrix. The informative visual image matrix visually links various points-of-interest on a visual image with a descriptor containing information about features of the points-of-interest. The concentric design of the informative visual image matrix creates an intuitive and integrated display easily accessible by a beginner.

### CROSS-REFERENCE TO RELATED APPLICATIONS

This application claims the benefit of U.S. Provisional Application No. 60/667,363, filed Apr. 1, 2005.

### STATEMENT REGARDING FEDERALLY-SPONSORED RESEARCH OR DEVELOPMENT

Not Applicable

### BACKGROUND OF THE INVENTION

1. Field of Invention

The invention relates to an informative visual image matrix conveying feature specific information about a visual image.

2. Description of the Related Art

Maps are useful tools for locating places, commonly referred to as a point-of-interest (POI). The primary types of information gleaned from a map is geographic information, such as proximity, i.e., how far away is the point-of-interest, and routing, i.e., how to get to the point-of-interest. In addition to the primary information, secondary information about the point-of-interest is often included. Examples of secondary information might include a listing of facilities or amenities. This is common and useful in specialty maps comparing similar points-of-interest, e.g., a map of all of the recreational parks or all of a company's hotel property within a specified geographic region. Here the recreation seeker or the consumer may have several viable alternatives meeting their geographic requirements with the alternatives differentiated only in the facilities and amenities offered. In such a case, the deciding factor between the alternatives maybe the availability of facilities or amenities.

On conventional maps, this secondary information is typically provided by way of a chart, or legend, that was the features or amenities. The list of features or amenities is crossed-referenced to the points-of-interest by means of a common identifier. For example, the list of hotels showing the amenities might be sequentially numbered in the legend with each geographic location marked by a corresponding numbered symbol on the map. Such a layout requires the reader of the map to perform the additional step of linking information from two separate data sources. In situations where the reader of the map is attempting to compare alternative points-of-interest, this will often include remembering multiple non-sequential identifiers. In the feature chart, the reader of the map is faced with a list of features separated by interposing data, creating unnecessary difficulty in assessing the features.

FIG. 1 illustrates a typical way to present feature information on a conventional map. The feature information is located in a legend located distant from the actual point-of-interest with no direct visual connection. The feature information and the point-of-interest are cross-referenced using a reference identifier. The reference identifier is often alpha-numeric or a color. The map reader must perform a relatively complex operation involving memory and searching to locate a point-of-interest that matches the desired characteristics, which typically include a combination of location and features weighted according to the reader's desires.

Assume a reader is searching for a hotel near a business meeting site that has a gym. The reader searches through the legend and locates a hotel having gym facilities. One example of a typical legend found on a conventional map is a chart containing columns representing an amenity and rows representing the hotels. For each hotel having a particular amenity, a dot is placed in the appropriate row and column. This requires the reader to search both horizontally and vertically to identify a hotel having the appropriate amenity. Once found, the reader memorizes the reference identifier and begins searching the map for a hotel having the corresponding reference identifier. If the located hotel is close enough to the meeting site, the search is complete. But assume that the meeting site is at point M and the first hotel having a gym located by the reader is hotel B, which is distant from point M. The reader continues searching looking at hotel D, also distant, before finding hotel F, which is relatively close to point M. Thus, the search involved several iterations to find a hotel both close to the meeting site and having the desired facilities.

Using another approach, the reader first locates the meeting site on the map and then identifies nearby hotel C. After consulting the legend, the reader is disappointed to find that hotel C does not have a gym. Next, the reader tries hotel E, also nearby, but finds no gym. Finally, hotel F is located that has both a gym and the desired proximity to point M. This approach also results in several iterations of memorizing and searching.

As illustrated, there is a certain level of complexity associated with cross-referencing location and feature information on conventional maps necessitated by the need to repeatedly refer to a legend or key to interpret the information. This same concern applies to other forms of communications, such as instructional photographs.

### BRIEF SUMMARY OF THE INVENTION

One embodiment of an informative visual image matrix according to the present invention for conveying information to a reader is as follows. The central portion of the informative visual image matrix is a visual image having points-of-interest about which further comparative information is desired. The visual image is any type of image where it is desirable to identify information about a specific object, feature, or location of the visual image, such as a map having a series of related locations, i.e., a park map. Each specific object or location is generally referred to as a point-of-interest. Each of the points-of-interest are identified by a marker and annotated with a label.

A series of parallel bands completely or partially bounds the visual image and contains information about a feature pertaining to the points-of-interest. By being located about the outside edge of the visual image, the bands do not obscure any part of the visual image. The bands are substantially concentric.

To convey the information, the informative visual image matrix uses descriptors to convey a specific understanding or awareness to the reader. The descriptors describe the amenities or features of the park. Words serve as obvious and universal descriptors because the reader is not forced to search for interpretive data in a legend or explanation of symbols. The descriptors can provide additional secondary information, such as any associated cost, the number available, or the hours of operation.

The descriptors are associated with the corresponding point-of-interest by a connector. The connector provides a conceptual and/or visual connection between the descriptors and the point-of-interest. A pointer extends from the connector towards each existing descriptor to provide further clarify the association between the descriptor and the point-of-interest.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a conventional map illustrating a typical presentation of feature information;

FIG. 2 is a map having feature information incorporating an informative visual image matrix according to the present invention; and

FIG. 3 is an illustration of an interactive informative visual image matrix having a single band selectively associated with tennis courts according to the present invention;

FIG. 4 is an illustration of the interactive informative visual image matrix of FIG. 3 having a single band where the selective association for the band has been change to soccer fields;

FIG. 5 is a screen shot of an embodiment of an interactive informative visual image matrix showing one form of visually connecting a point-of-interest with the associated descriptors;

FIG. 6 is a screen shot of an embodiment of an interactive informative visual image matrix showing another form of visually connecting a point-of-interest with the associated descriptors; and

FIG. 7 is a screen shot of an embodiment of an interactive informative visual image matrix showing a still further form of visually connecting a point-of-interest with the associated descriptors.

### DETAILED DESCRIPTION OF THE INVENTION

An informative visual image matrix usable with maps and other visual images to convey information about objects shown in the visual image is shown in the figures at 200 and described herein. The informative visual image matrix visually links various points-of-interest on a visual image with a descriptor containing information about features of the points-of-interest. The descriptors and the points-of-interest are visual linked in a manner suited for the medium of presentation. The design of the informative visual image matrix creates an intuitive and integrated display easily accessible by a beginner.

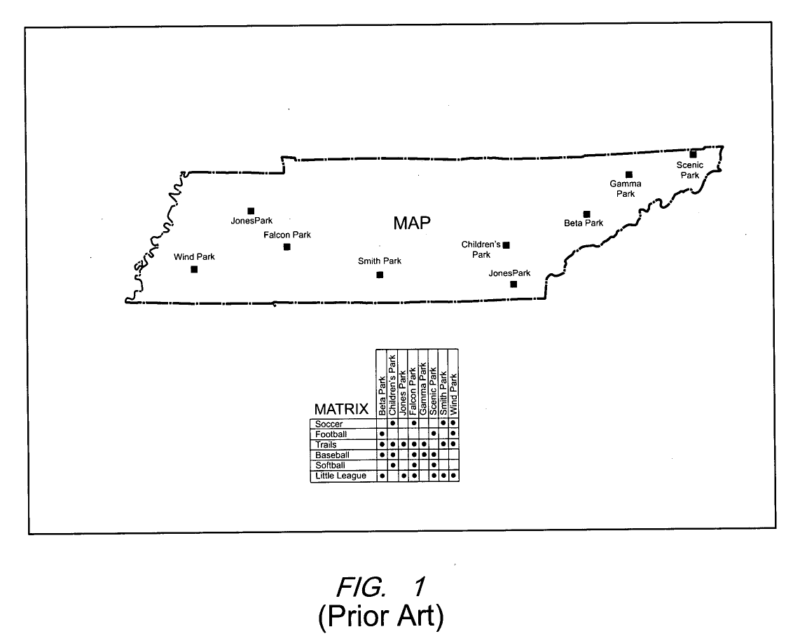

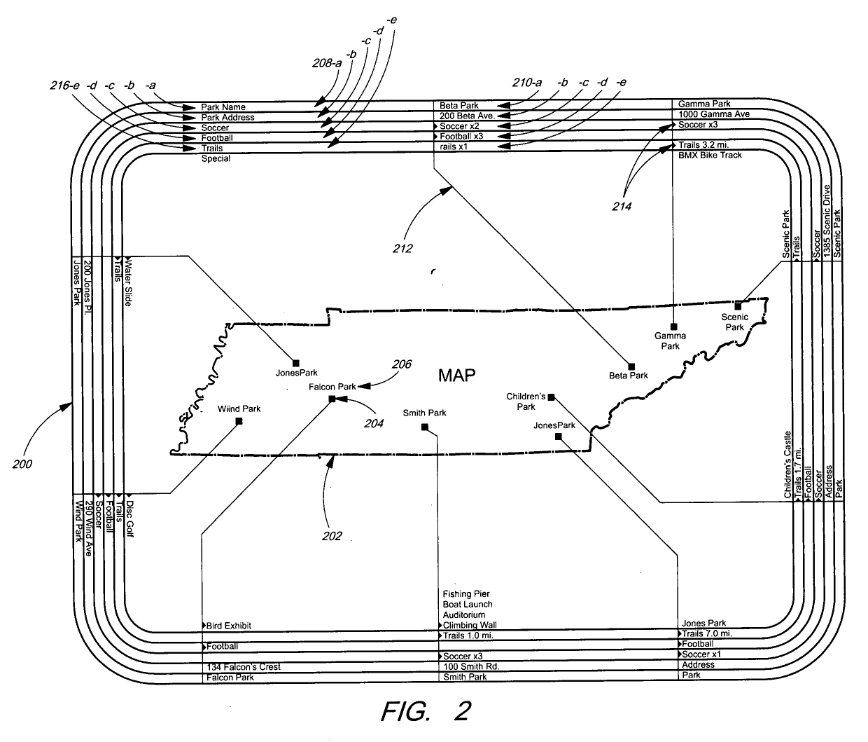

FIG. 2 is an illustration of one embodiment of a map informative visual image matrix 200 according to the present invention to convey information to the reader. In the central portion of FIG. 2 is a visual image 202. The visual image 202 illustrated in FIG. 1 is a map, and more specifically, as a park map. In other embodiments, differing types of visual images where it is desirable to identify information about a specific object, feature, or location of the visual image are used. Examples of suitable visual images used in other embodiments include illustrations, diagrams, and photographs. The specific object or location is generally referred to as a point-of-interest. In the illustrated embodiment, the points-of-interest are parks and recreation areas. Each of the points-of-interest are identified by a marker 204 and annotated with a label 206.

Around the visual image 202 is a series of parallel bands 208a-e that completely or partially bound the visual image 202 and contains information pertaining to a feature pertaining to the points-of-interest. By being located about the outside edge of the visual image, the bands do not obscure any part of the visual image. The bands 208a-e are substantially concentric. In the example of the map, the features shown in the bands are amenities found within state parks.

To convey the information, the informative visual image matrix 200 uses descriptors 210a-e to convey a specific understanding or awareness to the reader. The descriptors describe the amenities or features of the park. Examples of suitable descriptors include any word, phrase, number, letter, symbol, or other cue. Where standardized symbols or symbols likely to be understood by the reader are not available, words serve as universal descriptors. By using words, the reader is not forced to search for interpretive data in a legend or explanation of symbols. In various embodiments, the descriptors provide additional information beyond the presence or absence of the amenity, such as any associated cost, the number available, or the hours of operation. The descriptors are grouped in sets associated with a particular point-of-interest. Each member of the set represents a specific piece of information about the point-of-interest. The members of the various sets that are related by common subject matter are then grouped within a specific band, i.e., all the tennis court information is grouped together within a single band.

In one embodiment, the common descriptors are located within the same band and each band is identified by a band legend 216a-e. The band legend is a set of identifiers with each identifier being associated with one of the bands. The band legend allows the information conveyed by band to be identified generically. Further band legend provides a specific location to identify the information conveyed by each band and allows the reader to identify what features are missing from the point-of-interest, which is typically noted by the absence of a descriptor. Referring to the innermost band 208e of the illustrated embodiment, the band legend 216e indicates the band represents the availability of tennis courts. Scanning through the various descriptors located in the innermost band 208e, the reader sees specific information related to the availability of tennis courts. Where no descriptor exists proximate to a connector, the reader is made aware that the associated point-of-interest is lacking that feature or amenity. The descriptor for a point-of-interest having the feature includes more detailed information about the feature.

In one embodiment, the descriptor simply parrots the information from the band legend, for example, repeating the word “tennis” and may include secondary descriptor information as a quantifier indicating the number of courts. In other embodiments, the descriptor provides further details such as the composition of the court(s) (clay, asphalt, grass) or an honorary name of the amenity (“The John Smith Tennis Court”). Finally, in one embodiment, one or more bands are designated for miscellaneous features that are uncommon but are worthy of note. By adding a band devoted to miscellaneous information, uncommon features are listed as prominently as common features and the reader can quickly survey what unusual amenities are available.

The descriptors 210a-e are associated with the corresponding point-of-interest by a connector 212. The connector 212 provides a conceptual and/or visual connection between the descriptors and the point-of-interest. In one embodiment, a pointer 214 extends from the connector 216 towards each existing descriptor to provide further clarify the association between the descriptor and the point-of-interest. In the illustrated embodiment, the pointer 214 is a small, triangular arrowhead.

Although not necessary, a thematic link such as the use of a common color provides an obvious visual link indicating the relationship between the point-of-interest, the label 206, the descriptors 210a-e, the connector 212, and the pointer 214. The use of a common color allows the reader to grasp the interconnection of all these very small but highly significant elements, which in turn increases the intuitiveness of the informative visual image matrix 200. In one embodiment, the marker 204 shares the common color with the other elements. In another embodiment, each band 208a-e is assigned a distinct color or pattern or alternate shading allowing the reader to easily follow the desired band around the image when scanning.

In the illustrated embodiment, an outermost first band 208a contains the park name, a second band 208b contains the physical address of the park, a third band 208c conveys the presence or absence of soccer fields, a fourth band 208d conveys the presence or absence of football fields, and the innermost fifth band 208e conveys the presence or absence of trails.

The preceding section identified the basic structural features of the map. The foregoing section reviews the functions supported through the combination of the structural feature previously identified. The functions are integration, proximity arrangement, concentric arrangement, visual linking, efficient comparison, rapid location, focused information, simplification

The fact that the bands borders the visual image serves to make it unmistakably clear to the reader that the bands containing the descriptors are essential to correctly understanding the visual image. Further, readers familiar with distant, or independent tables, are alerted that assumptions based upon experience with prior art informative visual images, such as maps, do not necessarily apply. Finally, the integration reassures beginners that the information has an obvious and simple organization.

With proximity arrangement, the descriptions of the points-of-interest within the bands are arranged by geographic proximity rather than alphabetically. Once a geographically relevant point-of-interest has been located, scanning left and right allows the reader to compare the features and amenities of nearby points-of-interest. This functional arrangement allows the reader to quickly locate the closest point-of-interest having the desired feature without requiring the reader to refer to a legend that is isolated from the visual image.

Because the bands are concentrically arranged, the features and amenities maintain a consistent position relative to the visual image. This is in contrast to the feature table of conventional maps that utilize a top-to-bottom arrangement. Because of the concentric arrangement, the reader encounters the features described in the bands in the same order regardless of the direction to which the reader scans. For example, if the feature called “Trails” occupies the innermost position in the bands, “Trails” are the descriptor listed closest to the map at the top, bottom, and sides of the page.

Visual linking literally connects the point-of-interest with the descriptor describing the point-of-interest through the connector. The lines connecting the points-of-interest and the descriptor are highly visible and emphasizes the relationship between the points-of-interest and the descriptor. This direct and literal visual link eliminates the abstracted logic demanded by the separate legend such as those used on conventional maps is not required. Therefore, the reader is not required to possess prior knowledge of or training in the conventions used with non-integrated image and table legends in order to correctly utilize the informative visual image matrix of the present invention.

By following one band around the edges of the informative visual image matrix 200, the reader is able to quickly find and identify the points-of-interest having the desired feature or amenity. The bands provide efficient comparison of the available resources shown on the informative visual image matrix 200.

Closely related to efficient comparison is rapid location, when a desired feature or amenity is identified, the reader ascertains the location of the point-of-interest by simply following the connector rather than searching for a corresponding identifier. Rapid location dramatically reduces the amount of time required to do a simultaneous and exhaustive survey of the informative visual image matrix 200.

Focused information allows the informative visual image matrix to highlight specific and related features. For example, with respect to maps, a typical city infrastructure is widely varied. In a specific example, a city park map uses the informative visual image matrix to identify the features of all available park and recreation areas maintained by the city. The city could then take same basic map layout (the visual image) and create an entertainment map showing the locations of tourist attractions using the informative visual image matrix to identify the type of attraction and features such as cost and/or hours of operation.

By widening the focus, major points-of-interest might be identified. With a wider focus, each band on the informative visual image matrix represents a different classification of feature or amenity. For example, one band might represent transportation services, a second band might represent lodging, a third band might represent attractions, and a fourth band might represent dining. Such a general focus map would allow a visitor to quickly determine what area of the city is most central to the desired objectives of the visit. A map with different focus of showing schools, attractions, and major retail centers would be beneficial to someone moving into the area when deciding where to reside.

Depending upon the focus of the informative visual image matrix, non-essential information is removed for reasons such as to reduce clutter or otherwise simplify the informative visual image matrix. Referring again to a parks and recreation map, roads that are not necessary to reach the identified parks are eliminated without limiting the usefulness of the map. In one embodiment, portions of the visual image that have no points-of-interest relative to the informative visual image matrix are cropped or otherwise obscured in favor of information of a more general interest. In another embodiment, any point-of-interest appearing on the visual image that is so minor or rudimentary as to not require additional information is not connected to the bands surrounding the visual image. In this way, the limited space of the informative visual image matrix is conserved for the most complicated items. An example would be tiny neighborhood parks that have the barest of amenities.

It will be appreciated that the features of the informative visual image matrix 200 described herein are applicable regardless of the form of presentation. For example the informative visual image matrix is usable with printed matter or electronic representations. Variations and alternate embodiments exist regardless of the presentation medium.

In one embodiment, the focus of selected portions of the informative visual image matrix varies depending upon the needs of the visual image. For example, consider a city that is beside the ocean. A focus of the bands around the land show land-based amenities but in the area covered by water, the focus of the band adapts to show ocean and beach amenities. A corresponding change of band color or pattern helps the reader to intuitively understand the change in focus.

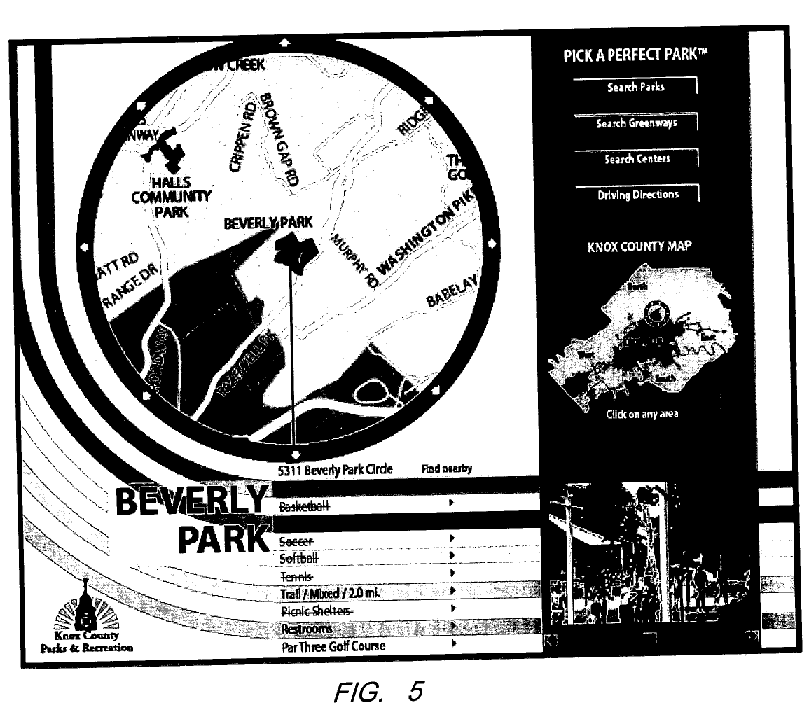

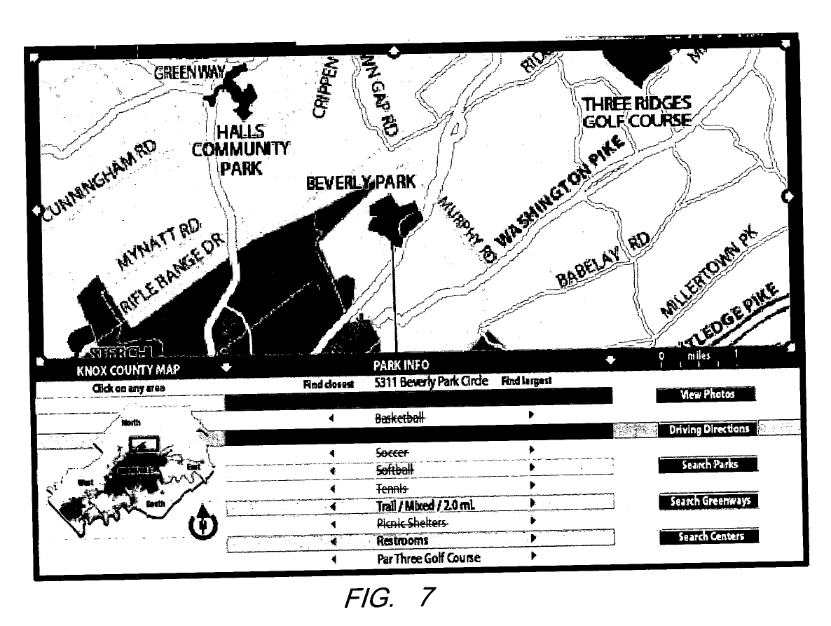

Maps and other informative visual images are traditionally produced on paper for reasons such as cost and portability. Printed informative visual images are obviously static. As electronic information delivery systems have evolved, so has the availability of dynamic information presentation. One desirable medium of presentation is through interactive computer-based informative visual images. These computer-based informative visual images are suited for use as web-pages or heads-up displays. FIGS. 5 and 7 illustrate alternate embodiments of an interactive informative visual image matrix.

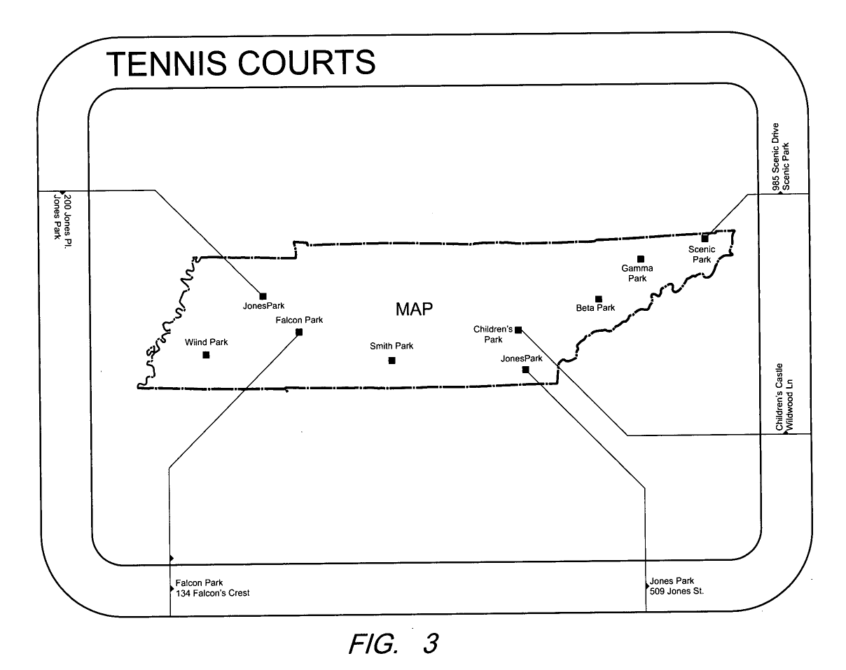

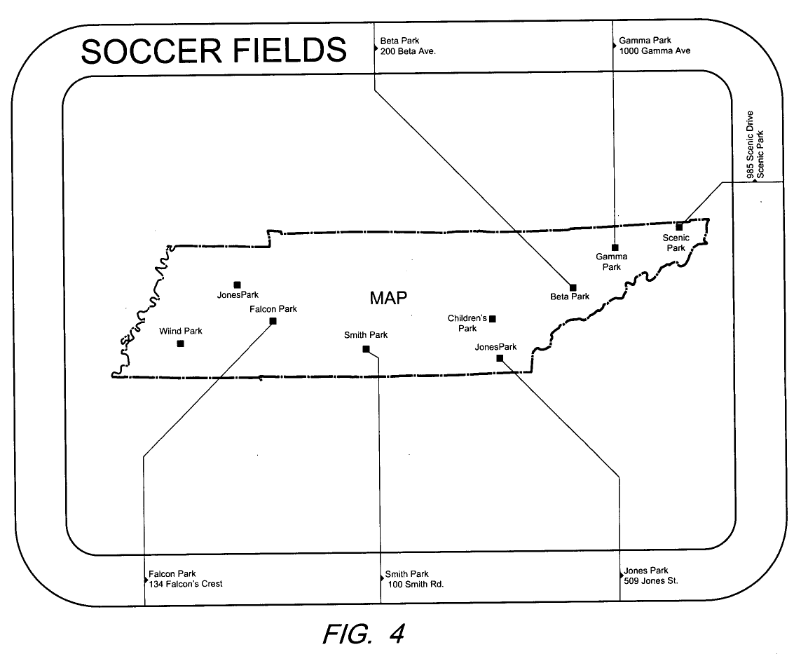

In one embodiment, the informative visual image matrix includes a single band. A single band might be selected to narrow the focus of the information presented, to limit the density of information presented at one time, or to accommodate size limitations of the display device. With a dynamic or interactive medium, the focus of the band is updated on an automated schedule or on the action of the reader. As an example, an informative visual image matrix might initially show only tennis courts on the visual image and the single band, as illustrated in FIG. 3. When the consumer clicks on the informative visual image matrix with a mouse, the tennis band is replaced with a soccer band and the points-of-interest on the visual image are updated, as illustrated in FIG. 4. In this way, the informative visual image matrix bands are viewed individually rather than all at once on a comprehensive informative visual image matrix.

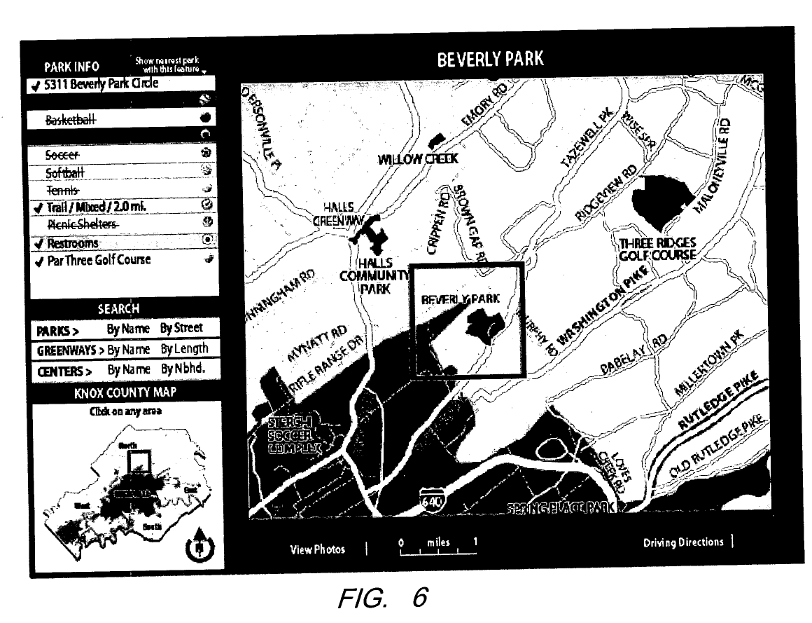

In another embodiment, multiple bands are used but the points-of-interest and the descriptors are not directly connected by connectors. Instead, the points-of-interest are highlighted according to an automated schedule or on the action of the reader. In one embodiment, when the reader clicks on a certain band of the informative visual image matrix, the corresponding points-of-interest are shown. As an example, a map of a city shows only streets and some natural landmarks. When the reader clicks on the “Football” band, the locations of football-related points-of-interest appear on the visual image. In another embodiment, the points-of-interest and the descriptors or bands are visually linked though the use of common colors, illumination, or other highlighting techniques. FIG. 6 illustrates an example of a visual linking using highlighting where the selected point-of-interest is framed and the bands associated with the various features contain descriptors specific to the highlighted point-of-interest.

In a still further embodiment, information from multiple bands is combined. Combining information allows the reader to quickly discern between possibilities when multiple criteria are used. Assume the reader is seeking a park having both softball fields and a picnic area in order to plan an outing for an organization. Some parks may have one or the other but not both while others meet both criteria. By selecting the bands for the two relevant criteria, the points-of-interest meeting the criteria are highlighted by creating a visual link between the combined band and the points-of-interest.

One implementation is to combine the colors of the bands where applicable. In the above example, if the picnic area band colored yellow and the softball band colored blue are selected, each of the corresponding points-of-interest are similarly colored. However, where both amenities exist, the points-of-interest take on a green color. In one embodiment, selection involves causing one of the desired bands to overlie another. In another embodiment, to or more individual bands are selected and a new band is created having a color that is distinct from those already used by the individual bands.

An alternate embodiment allows the reader to adjust the priority or prominence of the bands. The order to the bands is adjustable allowing the reader to move bands inwards towards the visual image or outwards towards the outer edge of the display in order to emphasize the band.

Various embodiments of the informative visual image matrix have been shown and described. The informative visual image matrix includes a visual image that shows various points-of-interest and one or more bands bounding the visual image. Each band contains a descriptor associated with each point of interest to indicate information such as the presence or absence of a particular feature or amenity and, optionally, secondary information pertinent to the feature. The descriptors and the points-of-interest are visual linked in a manner suited for the medium of presentation, including connector lines or interactive highlighting. The concentric design of the informative visual image matrix creates an intuitive and integrated display easily accessible by a beginner.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An apparatus comprising:
a visual image;
a first band surrounding said visual image, said first band representing a selected feature from a group of features;
a point-of-interest on said visual image, said point-of-interest represented by a marker on said visual image, said point-of-interest having said selected feature; and
a descriptor corresponding to said selected feature, said at least one descriptor located within said first band representing said selected feature, said at least one descriptor being visually linked to said point-of-interest.

2. The apparatus of claim 1 further comprising a label associated with and located proximate to said point-of-interest.

3. The apparatus of claim 1 further comprising a connector linking said descriptor with said point-of-interest.

4. The apparatus of claim 1 further comprising a connector linking said descriptor with said point-of-interest, said connector being a line having a first end terminating proximate to said point of interest and a second end terminating proximate to said descriptor.

5. The apparatus of claim 1 wherein said descriptor and a corresponding said point-of-interest are commonly highlighted to create a visual link.

6. The apparatus of claim 1 further comprising a connecting line having a first end terminating proximate to said point of interest and a second end terminating proximate to said descriptor and a pointer extending from said connecting line towards said descriptor thereby creating a visual link.

7. The apparatus of claim 1 wherein said apparatus further comprises at least a second band that, together with said first band, forms a plurality of bands, each of said plurality of bands being concentric.

8. The apparatus of claim 1 wherein said apparatus further comprises at least a second band that, together with said first band, forms a plurality of bands, each of said plurality of bands being visually distinct from each other of said plurality of bands.

9. The apparatus of claim 1 wherein said apparatus further comprises at least a second band that, together with said first band, forms a plurality of bands and a legend, said legend comprising a set of identifiers corresponding to said group of features, each of said set of identifiers associated with one of said plurality of bands to identify said selected feature associated with each of said plurality of bands.

10. The apparatus of claim 1 wherein said apparatus further comprises an identifier associated with said first band to identify said selected feature associated with said first band.

11. The apparatus of claim 1 wherein said apparatus is implemented in an interactive medium, said first band capable of being interactively replaced by a second band.

12. The apparatus of claim 1 wherein said apparatus is implemented in an interactive medium, said first band representing a first feature capable of being combined with a second band represent a second feature to create a combined band representing both said first feature and said second feature, said point-of-interest being visually linked with said combined band when said point-of-interest set of features includes both said first feature and said second feature.

13. The apparatus of claim 1 wherein said apparatus is implemented in an interactive medium and said apparatus further comprises at least a second band that, together with said first band, forms a plurality of bands, said plurality of bands having an order, said order being capable of interactively rearranged.

14. An apparatus comprising:
a visual image;
a plurality of points-of-interest on said visual image, each of said plurality of points-of-interest represented by a marker on said visual image, said plurality of points-of-interest having at least one feature from a group of selected features;
a plurality of bands surrounding said visual image, said plurality of bands concentrically arranged around said visual image, each of said plurality of bands being visually distinct from each other of said plurality of bands, each of said plurality of bands associated with one of said group of selected features;
a plurality of connectors, each of said plurality of connectors associated with one of said plurality of points-of-interest, each of said plurality of connectors having a first end terminating proximate to said marker associated with one of said plurality of points-of-interest and a second end intersecting with and terminating proximate to said plurality of bands;
a set of descriptors associated with one of said plurality of points-of-interest, said set of descriptors including at least one member associated with one of said associated plurality of points-of-interest at least one feature, each member of said set of descriptors located in a differing one of said plurality of bands proximate to said one of said plurality of connectors associated with said one of said plurality of points-of-interest that corresponds to said associated plurality of points-of-interest at least one feature.

15. The apparatus of claim 14 further comprising a set of identifiers corresponding to said group of common features, each of said set of identifiers located within one of said plurality of bands to identify said selected feature associated with each of said plurality of bands.

16. An apparatus comprising:
a visual image;
a plurality of bands surrounding said visual image, each of said plurality of bands representing a selected feature from a group of features;
a plurality of points-of-interest on said visual image, each of said points-of-interest represented by a marker on said visual image, each of said points-of-interest having a set of features from said group of features;
at least one descriptor, each of said at least one descriptor corresponding to a member of said point-of-interest set of features, each said at least one descriptor located within said first band representing said selected feature, said at least one descriptor being visually linked to said point-of-interest; and
a plurality of identifiers, each of said plurality of identifiers located within one of said plurality of bands to identify said selected feature associated with a particular one of said plurality of bands.

17. The apparatus of claim 16 further comprising a set of identifiers corresponding to said group of features, each of said set of identifiers associated with one of said plurality of bands to identify said selected feature associated with each of said plurality of bands.
